(19) United States
(12) Patent Application Publication
(10) Pub. No.: US 2007/0215450 A1
(43) Pub. Date: Sep. 20, 2007

(54) Slide switch

(75) Inventor: Liang Sun, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/725,690

(22) Filed: Mar. 20, 2007

(30) Foreign Application Priority Data
Mar. 20, 2006 (TW) 95204560

(51) Int. Cl. H01H 15/06

(52) U.S. Cl. 200/550

(57) ABSTRACT

A slide switch (100) comprises a housing (1), a plurality of stationary contacts (2) embedded in the housing, a slide member (4) moveably contained in the housing, a moveable contact (3) fixed to the slide member, and a cover (5) attached to the housing. The housing comprises a bottom surface (10) and a plurality of side surfaces (11) therearound, and said bottom surface and side surfaces cooperatively define a cavity. The moveable contact is fixed to said slide member to be connected to and disconnected from said stationary contacts. Each end of the housing defines a pair of protrusions (131) at upper portions of two lateral sides thereof, and therefore a channel is formed between said two protrusions. A pair of recesses (133) is defined below the protrusions respectively, and the recesses are recessed into the side surface of the end/channel.

### BACKGROUND OF THE INVENTION

1. Field of the Invention

The present invention relates to a slide switch for use in various electronic devices such as portable telephones and digital cameras.

2. General background

Nowdays, slide switches are widely used in various electronic devices such as portable telephones and digital cameras.

As shown in FIGS. 4-5, the conventional slide switch 100′ generally comprises an insulative housing 1′, a plurality of stationary contacts 2′ fixed in the housing, a slide member 4′ moveable mounted onto the housing, a moveable contact 3′ fixed onto the slide member, and a cover 5′ covering the housing and the slide member.

The housing 1′ has a substantially longitudinal configuration with a top opening, and the housing comprises a bottom surface 10′ and a plurality of side surfaces 11′ around said bottom surfaces. Said bottom surface and side surfaces cooperatively define a cavity for accommodating the slide member. The stationary contacts are embedded in the bottom surface of the housing. The slide member 4′ comprises a containing portion 42′ recessed in the cavity substantially in the center thereof and an operating portion 41′ extending out of the housing. The moveable contact 3′ is fixed to a lower surface of the slide member for connecting to or disconnecting from the stationary contacts.

Each end of the longitudinal housing 1′ defines a pair of protrusions 131′ at upper portions of two lateral sides thereof, and therefore a channel is formed between said two protrusions 131′. The cover 5′ comprises a longitudinal main body 50′ and a pair of retaining portion 51′ extending from two ends of the main body 50′. The retaining portion 51′ comprises a connecting portion 510′ and a perpendicular engaging portion 512′, and said connecting portion 510′ and engaging portion 512′ cooperatively define an inverted “T” shaped configuration. A pair of soldering tail 52′ extends from two ends of the engaging portion 512′ for connecting with a printed circuit board.

In assembly, the moveable contact 3′ is fixed to the slide member 4′. Then the slide member 4′ is mounted into the cavity of the housing 1′ from the top opening. The containing portion 42′ is received in the cavity and the operating portion 41′ extends out of the cavity from a cut out of the lateral side surface. When the cover 5′ is mounted onto the housing 1, the main body 50′ slightly attaches to the housing first. When the cover 5′ is pressed downwardly, the retaining portions 51′ of the cover 5′ will elastic deform outwardly and the engaging portion 512′ will scrape with the protrusions 131′. When the engaging portion 512′ scrapes through the protrusions 131′, the retaining portion 51′ returns back to keep close to the side surface of the ends/channels and to engage with the lower surface of the protrusions 131′. The cover therefore is attached to the housing and the slide member for preventing EMI.

In use, the slide switch 100′ is mounted onto a printed circuit board, and the stationary contacts 2′ connect with corresponding circuits of the printed circuit board. At this time, the moveable contact contacts with some predetermined stationary contacts. When the operating portion is actuated from a neutral position to another predetermined position, the moveable contact contacts with some other predetermined stationary contacts in the bottom surface. When the operating portion is actuated back in an opposite direction, the slide member will return to the neutral position under the pressure of the actuation.

However, one problem with this conventional slide switch is that the scrape between the engaging portion and the protrusions will generate crumb, and said crumb drops and is probably held between the side surface of the ends and corresponding retaining portions 51′. Therefore, the cover may not be mounted onto the housing tightly and reliable mechanical performance of the slide switch is reduced.

In view of the above, a new slide switch which overcomes the above-mentioned disadvantages is desired.

### SUMMARY

Accordingly, an object of the present invention is to provide a slide switch that can provide space for accommodating the protrusion crumb generated by the scrape between the engaging portion and protrusions, therefore ensuring reliable mechanical performance of the slide switch.

A slide switch comprises a housing, a plurality of stationary contacts embedded in the housing, a slide member moveably contained in the housing, a moveable contact fixed to the slide member, and a cover attached to the housing. The housing comprises a bottom surface and a plurality of side surfaces therearound, and said bottom surface and side surfaces cooperatively define a cavity. The moveable contact is fixed to said slide member to be connected to and disconnected from said stationary contacts. At lease one side surface of the housing defines a pair of protrusions at upper portions of two lateral sides thereof, and therefore a channel is formed between said two protrusions. A pair of recesses is defined below the protrusions respectively, and the recesses are recessed into the side surface of the end/channel. When the cover mounts onto the housing, the crumb generated by the scrape between the cover and the protrusions will drop into the cavity, and the engagement between the housing and the cover will not be affected by the crumb. Therefore reliable mechanical performance of the switch is ensured.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a slide switch in accordance with the preferred embodiment of the present invention;

FIG. 2 is a side plan view of the housing in FIG. 1;

FIG. 3 is an isometric view of the assembled slide switch of FIG. 1;

FIG. 4 is an exploded, isometric view of a conventional slide switch; and

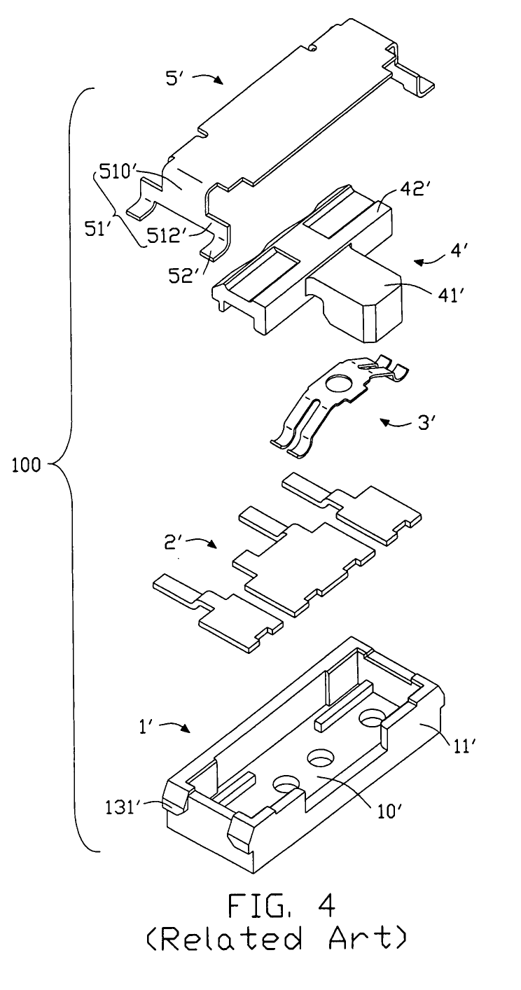

FIG. 5 is an isometric view of the assembled slide switch of FIG. 4.

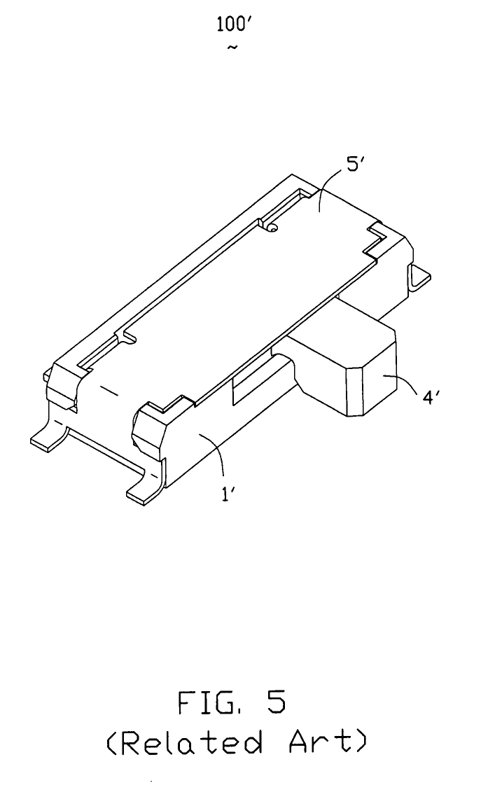

### DETAILED DESCRIPTION OF THE PREFERRED EMBODIMENT OF THE INVENTION

Reference will now be made to the drawings to describe the present invention in detail.

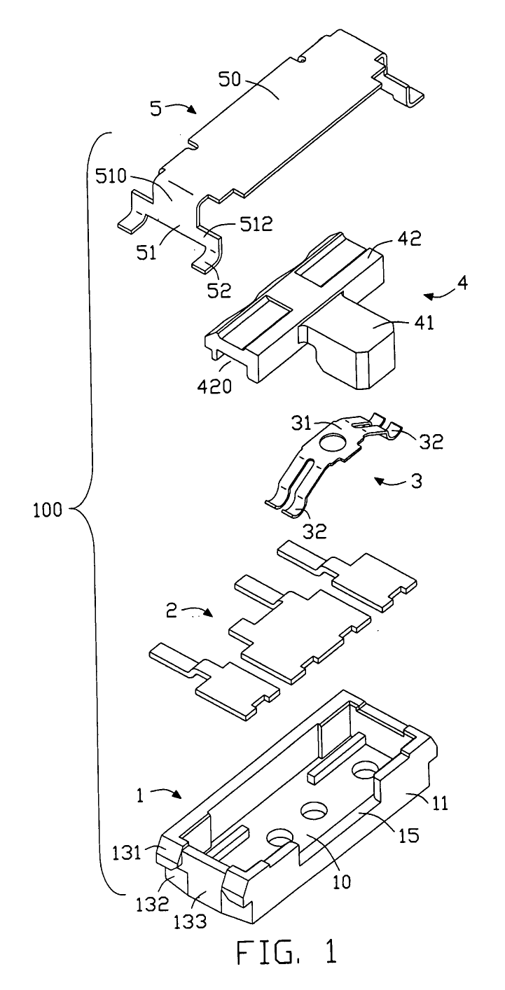

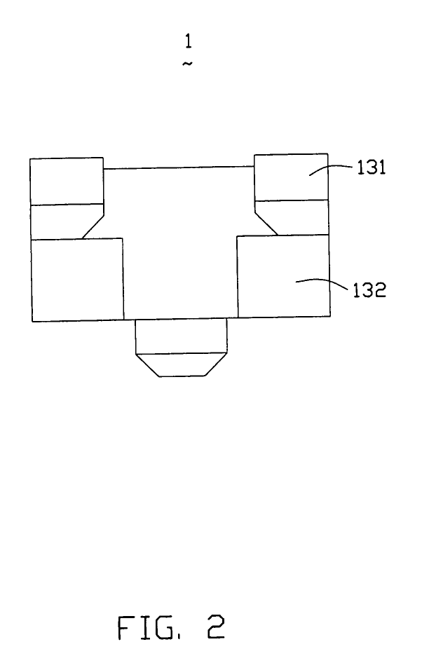

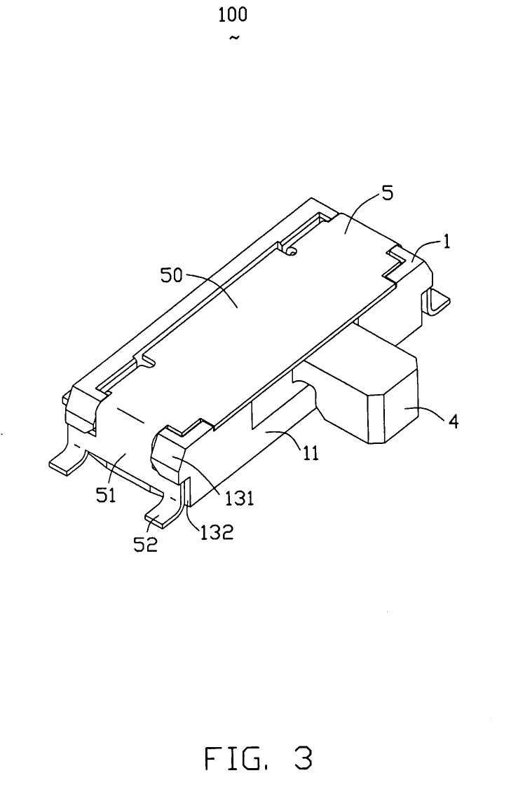

Referring to FIGS. 1-3, a slide switch 100 in accordance with the preferred embodiment of the present invention comprises a housing 1 with a bottom surface 10 and a plurality of side surfaces 11 around the bottom surface, a plurality of stationary contacts 2 embedded in the bottom surface of the housing 1, a slide member 4 moveably contained in the housing, a moveable contact fixed onto the slide member, and a cover 5 attached to the housing 1. The moveable contact 3 is fixed to said slide member 4 to be connected to and disconnected from said stationary contacts 2.

The housing 1 has a longitudinal configuration. The bottom surface 10 and the side surface 11 cooperatively define a cavity with a top opening. One of the longitudinal side surfaces 11 defines a cut out 15 substantially at the middle thereof. The stationary contacts 2 are embedded in the bottom surface along the longitudinal direction. Each end of the housing 1 defines a pair of protrusions 131 at upper portions of two lateral sides thereof, and therefore a channel 133 is formed between said two protrusions 131. Each end of the housing further defines two recesses 132 below the protrusions 131, and the recesses 131 are recessed into the side surface of the end/channel 133.

The slide member 4 comprises an operating portion 41 and a containing portion 42 recessed in the cavity substantially in the center thereof. The containing portion 42 defines a longitudinal recess 420 in a lower surface thereof along the longitudinal direction for fixing and accommodating the moveable contact 3 therein. The moveable contact 3 is slightly bent and comprises a center fixing portion 31 and two contacting portions 32 at both ends thereof. The moveable contact 3 can move along with the slide member 4 for connecting to or disconnecting from some predetermined stationary contacts 2.

The cover 5 comprises a longitudinal main body 50 and a pair of retaining portion 51 extending from two ends of the main body 50. The retaining portion 51 comprises a connecting portion 510 and a perpendicular engaging portion 512, and said connecting portion 510 and engaging portion 512 cooperatively define an inverted “T” shaped configuration. A pair of soldering tails 52 extends from two ends of the engaging portion 512 for connecting with a printed circuit board (not shown).

In assembly, the moveable contact 3 is fixed to the recess 420 of the containing portion 42 via the center fixing portion 31. Then the slide element 4 is mounted into the housing from the top opening, with the containing portion 42 received in the cavity and the operating portion 41 extending out of the housing from the cut out 15 of the lateral side surface 11. When the cover 5 is mounted onto the housing 1, the main body 50 slightly attaches to the housing first. When the cover 5 is pressed downwardly, the retaining portions 51 of the cover 5 will elastic deform outwardly and the engaging portion 512 will scrape with the protrusions 131. When the engaging portion 512 scrapes through the protrusions 131, the retaining portion 51 auto-returns back to keep close to the side surface of the ends/channels and to engage with the lower surface of the protrusions 131. The cover therefore is attached to the housing and the slide member for preventing EMI. During mounting of the cover onto the housing, the engaging portion 512 of the cover 5 will engage with the protrusions 131, and the scrape between the engaging portion and the protrusions will generate crumb. Said crumb drops into the recesses 132 and therefore will not be undesirably held between the side surface of the end and corresponding retaining portion 51. Therefore the retaining portion of the cover 5 can keep close to the side surfaces of the ends, and the cover can be mounted onto the housing tightly to ensure reliable mechanical performance of the slide switch.

In use, the slide switch 100 is mounted onto a printed circuit board, and the stationary contacts 2 connect with corresponding circuits of the printed circuit board. At this time, the moveable contact 3 contacts with some predetermined stationary contacts 2. When the operating portion 41 is actuated from the neutral position to another predetermined position, the moveable contact 3 contacts with some other predetermined stationary contacts 2 in the bottom surface 10. When the operating portion 41 is actuated back in an opposite direction, the slide member 4 will return to the neutral position. Therefore, different connections are achieved by different operations of the slide member.

While preferred embodiment in accordance with the present invention has been shown and described, equivalent modifications and changes known to persons skilled in the art according to the spirit of the present invention are considered within the scope of the present invention as defined in the appended claims.

What is claimed is:

1. A slide switch comprising:
a housing comprising a bottom surface and a plurality of side surfaces therearound, said bottom surface and side surfaces cooperatively defining a cavity, at least one side surface of the housing defining a plurality of protrusions;
a plurality of stationary contacts embedded in the bottom surface of the housing;
a slide member comprising a containing portion and an operating portion, the containing portion moveably mounted into the cavity;
a moveable contact fixed in a lower surface of the slide member;
a cover attached to the housing and the slide member, the cover comprising a main body and a pair of retaining portions extending from two opposite ends of the main body;
wherein a plurality of recesses is defined below said protrusions for accommodating crumb generated by the scrape between the cover and the protrusions.

2. The slide switch as claimed in claim 1, wherein the protrusions are defined at upper portions of two lateral sides of two ends of the housing.

3. The slide switch as claimed in claim 2, wherein the retaining portion comprises a connecting portion and a perpendicular engaging portion, and the connecting portion and engaging portion cooperatively define an inverted “T” shaped configuration.

4. The slide switch as claimed in claim 3, wherein a channel is defined between said protrusions, and said connecting portion extends through said channel.

5. The slide switch as claimed in claim 4, wherein the moveable contact comprises a fixing portion and two contacting portions at both ends thereof.

6. A slide switch comprising:
a housing comprising a bottom surface and a plurality of side surfaces therearound, said bottom surface and side surfaces cooperatively defining a cavity, at least one side surface of the housing defining a plurality of protrusions;
a plurality of stationary contacts embedded in the bottom surface of the housing;
a slide member comprising a containing portion and an operating portion, the containing portion moveably mounted into the cavity;
a moveable contact fixed in a lower surface of the slide member;
a cover attached to the housing and the slide member, the cover comprising a main body and a pair of retaining portions extending from two opposite ends of the main body, the retaining portion comprising a connecting portion and a perpendicular engaging portion, the connecting portion and engaging portion cooperatively defining an inverted “T” configuration, said engaging portion engaging with lower surfaces of said protrusions;
wherein a plurality of recesses is defined below said protrusions for accommodating crumb generated by the scrape between the cover and the protrusions.

7. The slide switch as claimed in claim 6, wherein the protrusions are defined at upper portions of two lateral sides of two ends of the housing.

8. The slide switch as claimed in claim 7, wherein a channel is defined between said protrusions, and said connecting portion extends through said channel.

9. The slide switch as claimed in claim 8, wherein the moveable contact comprises a fixing portion and two contacting portions at both ends thereof.

10. The slide switch as claimed in claim 9, wherein the slide member defines a recess at lower surface thereof, and the moveable contact is fixed in said recess.

11. A slide switch comprising:
an insulative housing defining a least one protrusion on an exterior face;
a plurality of fixed contacts disposed in the housing;
a slide member mounted in the housing so as to actuate at least one moveable contact to selectively engage at least one of the fixed contacts; and
a metallic cover defining an engaging portion to be latched to an underside of the protrusion; wherein
the exterior face defines a region under said protrusion, and the engaging portion does not intimately abut against the region but with a gap formed therebetween so as to forgive crumbs due to scrapping.

12. The slide switch as claimed in claim 11, wherein the gap is formed by a recess in the exterior face.
